(19) United States
(12) Patent Application Publication
(10) Pub. No.: US 2025/0324001 A1
(43) Pub. Date: Oct. 16, 2025

(54) INFORMATION PROCESSING APPARATUS, METHOD, AND NON-TRANSITORY COMPUTER READABLE STORAGE MEDIUM

(71) Applicant: CANON KABUSHIKI KAISHA, Tokyo (JP)

(72) Inventor: TOMOYA MIYOSHI, Kanagawa (JP)

(21) Appl. No.: 19/173,509

(22) Filed: Apr. 8, 2025

(30) Foreign Application Priority Data
Apr. 11, 2024 (JP) 2024-063790

(51) Int. Cl. H04N 1/00

(52) U.S. Cl. CPC H04N 1/00029; H04N 1/00076

(57) ABSTRACT

An information processing apparatus that is directly connectable to each of a plurality of wired lines includes at least one memory that stores instructions and at least one processor. The at least one processor, by executing the instructions, causing the information processing apparatus to execute a job using any of the plurality of wired lines, store job information about one or more jobs executed by the information processing apparatus, in a storage of the information processing apparatus, receive a selection of an record from among records each relating to a corresponding job of the one or more jobs that are managed based on the job information stored in the storage, and perform a diagnostic on a wired line used in a job corresponding to the selected record.

### BACKGROUND

### Field of the Disclosure

The present disclosure relates to a technique for performing diagnostics regarding networks in an information processing apparatus.

### Description of the Related Art

The present disclosure relates to an information processing apparatus that performs a job for transmitting data to other personal computers (PCs) or other information processing apparatuses.

There are numerous types of information processing apparatuses that process image data and other information, and they come in a wide variety. These information processing apparatuses are prone to malfunctions. When a malfunction occurs, it needs to be repaired, but users often struggle because they do not know the cause of the malfunction. To solve this, apparatuses including diagnostic means for identifying the cause of the malfunction and provide it to the user have been proposed. Hereafter, a multifunctional peripheral is described below as an example of the information processing apparatus.

On the other hand, the increasing complexity of security and functionality demanded by networks necessitates environments that can selectively use a plurality of Local Area Networks (LANs) as discussed in Japanese Patent Application Laid-Open No. 2020-154832. Information processing apparatuses used in such environments are demanded to provide services to the plurality of LANs. Therefore, a configuration in which the plurality of LANs is connected to a single multifunctional peripheral has been proposed.

As diagnostic means described above, it has been proposed to select a job to be executed by an information processing apparatus, and perform diagnostics regarding the job. In a case where the selected job involves transmitting data to other apparatuses, diagnostics are to be performed on a line. Here, diagnostics on a configuration in which one LAN is connected to one information processing apparatus have been proposed so far.

Thus, in a case where diagnostics on a configuration in which a plurality of LANs are connected to one information processing apparatus are performed, the diagnostics may be performed on a LAN different from a LAN used for the selected job. In this case, accurate diagnostics cannot be performed, and the user cannot identify the cause of the malfunction in the information processing apparatus.

### SUMMARY

According to an aspect of the present disclosure, an information processing apparatus that is directly connectable to each of a plurality of wired lines includes at least one memory that stores instructions and at least one processor. The at least one processor, by executing the instructions, causing the information processing apparatus to execute a job using any of the plurality of wired lines, store job information about one or more jobs executed by the information processing apparatus, in a storage of the information processing apparatus, receive a selection of a record from among records each relating to a corresponding job of the one or more jobs that are managed based on the job information stored in the storage, and perform a diagnostic on a wired line used in a job corresponding to the selected record.

Further features of various embodiments will become apparent from the following description of exemplary embodiments with reference to the attached drawings.

### BRIEF DESCRIPTION OF THE DRAWINGS

FIG. 1 is a diagram illustrating an example of a connection form between a multifunctional peripheral (MFP) and gateways according to a first exemplary embodiment of the present disclosure.

FIG. 2 is a diagram illustrating a hardware configuration example of the MFP according to the first exemplary embodiment of the present disclosure.

FIG. 3 is a diagram illustrating a software configuration example of the MFP according to the first exemplary embodiment of the present disclosure.

FIG. 4 is a diagram illustrating an example of a print job history list according to the first exemplary embodiment of the present disclosure.

FIG. 5 is a diagram illustrating an example of a diagnosis result according to the first exemplary embodiment of the present disclosure.

FIG. 6 is a flowchart of processing to be performed by the MFP according to the first exemplary embodiment of the present disclosure.

FIG. 7 is a diagram illustrating a configuration example of the diagnosis result according to the first exemplary embodiment of the present disclosure.

FIG. 8 is a diagram illustrating another configuration example of the diagnosis result according to the first exemplary embodiment of the present disclosure.

FIG. 9 is a diagram illustrating an example of a print job history list according to a second exemplary embodiment of the present disclosure.

FIG. 10 is a flowchart of processing to be performed by an MFP according to the second exemplary embodiment of the present disclosure.

FIG. 11 is a diagram illustrating a configuration example of a diagnosis result according to a third exemplary embodiment of the present disclosure.

FIG. 12 is a flowchart of processing to be performed by an MFP according to the third exemplary embodiment of the present disclosure.

FIG. 13 is a diagram illustrating a configuration example of diagnostic setting according to the third exemplary embodiment of the present disclosure.

### DESCRIPTION OF THE EMBODIMENTS

### <System Configuration>

A first exemplary embodiment of the present disclosure will be described. In the present exemplary embodiment, network diagnostic processing is described by using a multifunctional peripheral (MFP) that includes two communication lines, namely, a main line (first wired line) and a sub-line (second wired line), as an example. A configuration in which a plurality of wired lines is connected is described as an example. However, the technique is applicable to virtually separated communication lines using virtual network interfaces. An information processing apparatus is not limited to the MFP, and may be an information processing apparatus providing other functions.

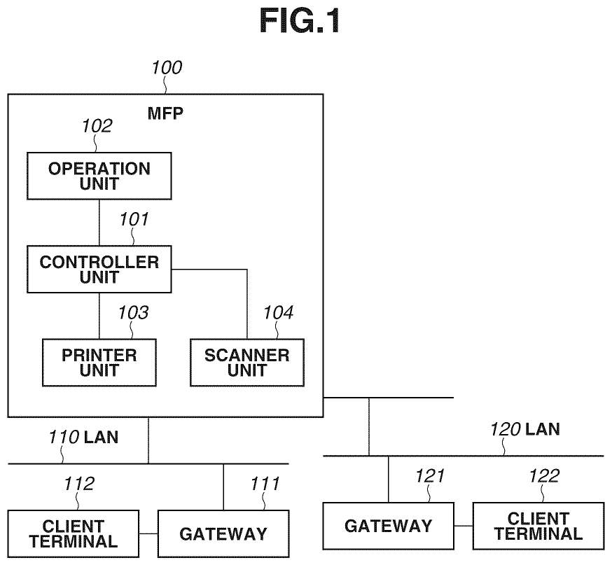

FIG. 1 is a diagram illustrating a connection form of the MFP, gateways, and client terminal, such as personal computers (PCs), according to the present exemplary embodiment.

An MFP 100 includes a controller unit 101, an operation unit 102, a printer unit 103, and a scanner unit 104. Details of a configuration of the controller unit 101 are described below. The operation unit 102 is an interface for input and output with a user. The printer unit 103 includes a printing unit that can output electronic data to a paper medium. The scanner unit 104 includes a reading unit that can read an image, and converts a read image into electronic data. The operation unit 102, the printer unit 103, and the scanner unit 104 are connected to the controller unit 101, and realize functions of the multifunctional peripheral under the control of the controller unit 101. The units included in the MFP 100 are not limited to these units, and units providing other functions may be included.

The MFP 100 and a client terminal 112 are communicably connected to each other via a local area network (LAN) 110 and a gateway 111. Apparatuses other than the MFP 100, such as the client terminal 112 and a client terminal 122, are referred to as the other apparatuses. The MFP 100 and the client terminal 122 are communicably connected to each other via a LAN 120 and a gateway 121. The gateway 111 and the gateway 121 are network rooters that relays communication from the MFP 100 with the client terminal 112 and the client terminal 122. Each of the client terminal 112 and the client terminal 122 shares a file with the MFP 100 and transmits a print request to the MFP 100 by, for example, a server message block (SMB) protocol.

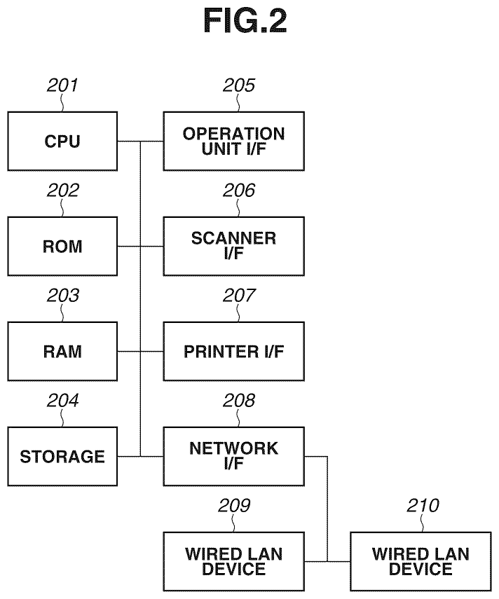

A hardware configuration of the MFP 100 according to the present exemplary embodiment is described with reference to FIG. 2.

FIG. 2 is a block diagram illustrating the hardware configuration of the MFP 100. The MFP 100 has a reading function of reading an image on a sheet, a file transmission function of transmitting a read image to an external communication apparatus, and other functions. The MFP 100 also includes a printing function of printing an image on a sheet. The MFP 100 includes a function of receiving a print job from the client terminal 112 and printing the print job.

A central processing unit (CPU) 201 controls the entire operation of the MFP 100. The CPU 201 reads out control programs stored in a read only memory (ROM) 202 or a storage 204, and the CPU 201 performs various types of control, such as printing control and reading control.

The ROM 202 stores the control programs to be executed by the CPU 201.

A random access memory (RAM) 203 is a main storage memory accessed by the CPU 201, and the RAM 203 is used as a work area or a temporary storage area into which various types of control programs are loaded.

The storage 204 stores print jobs, image data, various types of programs, and various types of setting information. Thus, hardware devices, such as the CPU 201, the ROM 202, the RAM 203, and the storage 204, configure a computer. In the MFP 100 according to the present exemplary embodiment, a single CPU 201 performs processes illustrated in the flowcharts described below by using a single memory (RAM 203), but other forms may be adopted. For example, a plurality of processors, memories, and storages may be caused to cooperate with one another to perform the processes illustrated in the flowcharts described below. The processes may be partially performed by a hardware circuit.

The CPU 201 is connected to the operation unit 102 illustrated in FIG. 1 via an operation unit interface (I/F) 205, and the CPU 201 realizes user input and output with the operation unit 102. The CPU 201 is connected to the printer unit 103 illustrated in FIG. 1 via a printer I/F 207, and the CPU 201 realizes sheet medium output processing (print processing) using the printer unit 103. The CPU 201 is connected to the scanner unit 104 illustrated in FIG. 1 via a scanner I/F 206, and the CPU 201 realizes document read processing (scan processing) using the scanner unit 104.

Wired LAN devices 209 and 210 are connected to a network I/F 208. In the present exemplary embodiment, a form in which the two wired LAN devices 209 and 210 are connected to the network I/F 208 is described. However, some forms are not limited thereto, and the present exemplary embodiment can be applied to the other LAN devices, such as a wireless LAN device and a LAN device connected to a universal serial bus (USB) port, and to the other connection forms. The CPU 201 controls the wired LAN device 209, via the network I/F 208, to realize communication on the LAN 110. The CPU 201 controls the wired LAN device 210 to realize communication on the LAN 120.

### <Software Configuration>

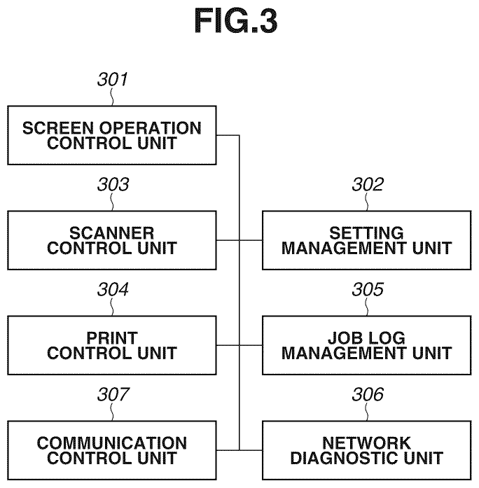

FIG. 3 is a block diagram illustrating a software configuration of the MFP 100 according to the present exemplary embodiment.

A screen operation control unit 301 performs control to display a screen for issuing a scan operation instruction via the operation unit 102 and to display the results of printing, the transmission of scan data, and the results of processing performed by a network diagnostic unit, which will be described below.

A setting management unit 302 manages the setting of various types of functions of the MFP 100.

Various types of setting values include, for example, setting values for the following: scanning, a sheet to be used in print processing, image processing, and communication with a communication terminal. These setting values are stored in a nonvolatile area, such as the storage 204, and are stored irrespective of a power state of the MFP 100.

The setting management unit 302 performs control to retrieve the setting values from the nonvolatile area, and the setting management unit 302 performs control to change a setting value to a different setting value and store the result.

A scanner control unit 303 issues an instruction to transmit predetermined data, obtained by the MFP 100 through scanning with the scanner unit 104, to other apparatuses, such as the client terminals 112 and 122.

The scanner control unit 303 acquires setting values, to be used for scan processing and scan data transmission processing, via the setting management unit 302, and the scanner control unit 303 issues an instruction to transmit scan data to a destination terminal via a communication control unit 307.

A print control unit 304 receives a print job received by the MFP 100 from another apparatus, and the print control unit 304 causes the printer unit 103 to perform a series of print processing up to sheet discharge processing via the printer I/F 207. The print control unit 304 acquires setting values to be use for the print processing via the setting management unit 302, analyses the received print job, performs image processing, and performs printing and sheet discharge processing.

A job log management unit 305 manages information about the results of print processing and scan processing.

Job processing result information includes information indicating the success or failure of processing. In a case of failure, the result information may include a network diagnosis result received from a network diagnostic unit 306.

The job processing result information is stored in the nonvolatile area, such as the storage 204, or in a job log management server on the network, and the job processing result information is stored irrespective of the power state of the MFP 100.

The job log management unit 305 receives the results of processing performed by the scanner control unit 303 and the print control unit 304, and the job log management unit 305 stores the results in the nonvolatile area or the job log management server.

In addition, the job log management unit 305 retrieves the job processing result information from the nonvolatile area, and the job log management unit 305 transfers the job processing result information to the screen operation control unit 301. The screen operation control unit 301 displays the job processing result information on the operation unit 102.

The network diagnostic unit 306 performs validity verification of network communication settings stored by the MFP 100, in the configuration illustrated in FIG. 1.

The validity verification involves, for example, verifying that the settings for an internet protocol (IP) address, subnet mask, and the gateway 111, which are to be used for network communication with the LAN 110, are correct. Additionally, the network diagnostic unit 306 verifies that the client terminal 112 and the MFP 100 are not using the same IP address.

The network diagnostic unit 306 periodically diagnoses states of physical communication links to the connected LANs 110 and 120. The periodic diagnostic is performed in response to instructions from the screen operation control unit 301, the scanner control unit 303, and the print control unit 304. Further, in a case where the network diagnostic unit 306 detects that a communication link has been disconnected, the network diagnostic unit 306 notifies the screen operation control unit 301, the scanner control unit 303, and the print control unit 304 of the communication link disconnection.

The network diagnostic unit 306 includes a diagnostic unit that performs diagnostics of the information processing apparatus. The diagnostic unit can check a state of the information processing apparatus. For example, in a case where communication with the client terminal(s) 112 and/or 122 serving as communication partners fails during transmission of scan data or during a print process, the diagnostic unit can diagnose the cause of failure. The diagnostic unit for identifying the cause of failure includes performing checks for connectivity with the client terminals 112 and 122 and conducting test communications.

The communication control unit 307 performs network communication control to transmit scan data to the client terminals 112 and 122 in response to the transmission instruction from the scanner control unit 303.

For the configuration including the wired LAN devices 209 and 210 as in the present exemplary embodiment, the MFP 100 can store two types of media access control (MAC) addresses and IP addresses as a multihomed network environment, enabling communication via both the LANs 110 and 120. The communication control unit 307 performs communication control by identifying a partner terminal and establishing a network connection in the multihomed network environment.

### <Screen Configuration>

Error guidance will now be described.

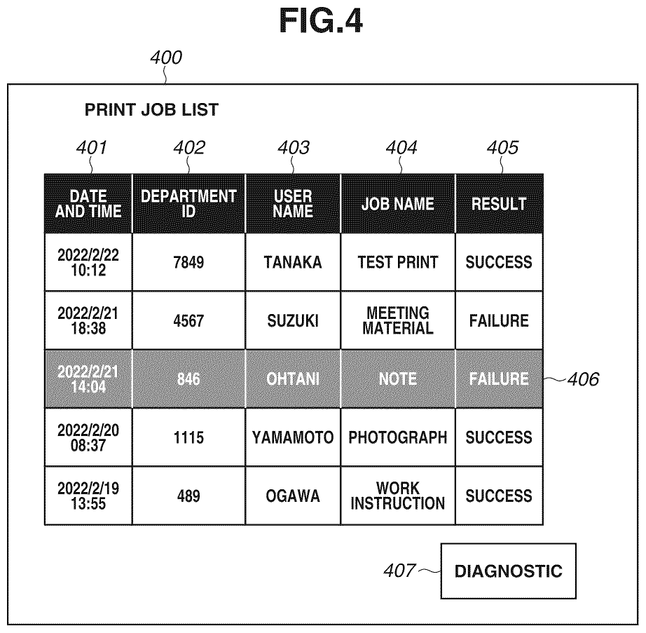

FIGS. 4 to 6 illustrate examples of the error guidance and the like.

FIG. 4 is a diagram illustrating an example of a print job history list that is managed in the storage 204 by the print control unit 304 and is displayed on the operation unit 102 of the MFP 100. In a print job list 400, where records of the history of print jobs executed by the MFP 100 are displayed as a list, a date and time 401, a department identification (ID) 402, a user name 403, a job name 404, and a result 405 are managed in association with one another.

The date and time 401 displays the date and time when a job is executed. The department ID 402 displays an ID of a department to which the user corresponding to the user name 403 having executed the job belongs.

The user name 403 displays a name of a user having executed the job, and the job name 404 displays a name of the executed job.

The result 405 displays an execution result of the job.

In the print job list 400, values of the data fields 401 to 405 are displayed as respective items (respective history records). As described above, each item includes information about a single job. The user can select this item. The MFP 100 can receive the user's selection through the operation unit 102 included in the MFP 100. When an item 406 on FIG. 4 is selected through the operation unit 102, and the operation unit 102 further receives the selection of a diagnostic button 407, a diagnostic starts.

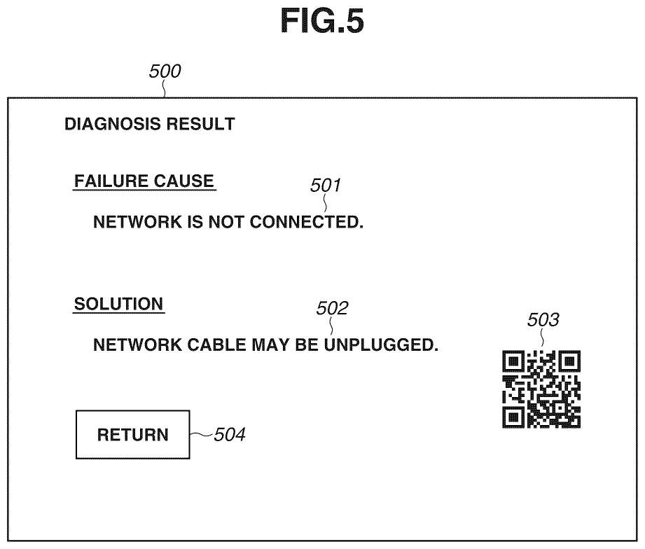

FIG. 5 is a diagram illustrating an example of a diagnosis result displayed by a display unit. The diagnosis result is displayed on the operation unit 102 of the MFP 100 by the display unit. The diagnosis result is a result of the diagnostic performed by the network diagnostic unit 306, on the item received by the operation unit 102.

A diagnosis result 500 is displayed when the user operates the operation unit 102 and presses the diagnostic button 407, and the network diagnostic performed in response to the user operation is completed. A cause-of-failure description message 501 displays a message describing the cause of a job failure. A solution description message 502 displays the solution corresponding to the failure cause displayed in the cause-of-failure description message 501. In a case where the solution for the cause of failure is described in a user manual browsable on a web, a two-dimensional code 503 indicating a uniform resource locator (URL) of the user manual is displayed. When a return button 504 is pressed, the display is returned to the print job list 400 in which the diagnostic button 407 has been pressed.

In the present exemplary embodiment, the print job is described as an example; however, a history list of scan jobs or the like can be similarly displayed. The associated data fields are not limited to those described in the example.

### <Processing Flow>

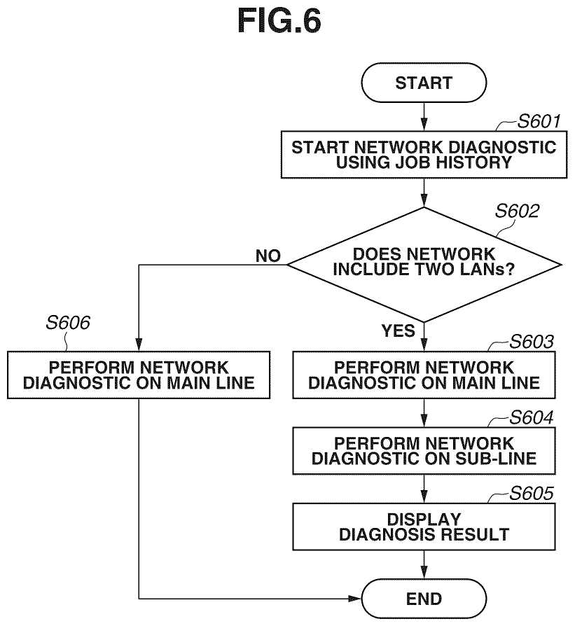

The network diagnostic processing using a job history according to the present exemplary embodiment will now be described with reference to FIG. 6.

In step S601, the operation unit 102 of the MFP 100 receives a selection of an item and a selection of the diagnostic button 407. The user presses buttons corresponding thereto. A network diagnostic is then started.

In step S602, the network diagnostic unit 306 included in the MFP 100 determines a setting of a line. More specifically, the network diagnostic unit 306 determines whether the network includes a dual network (i.e., two LAN systems). In the present exemplary embodiment, the network diagnostic unit 306 determines whether the setting of the line is a setting that allows the use of both the main line (first wired line) and the sub-line (second wired line) (such a setting is referred to as a first setting) or is a setting that allows the use of only the main line (such a setting is referred to as a second setting). If a determination result is the first setting (YES in step S602), the processing proceeds to step S603. If the determination result is the second setting (NO in step S602), the processing proceeds to step S606.

In step S603, the network diagnostic unit 306 initially performs a network diagnostic on the main line.

In step S604, the network diagnostic unit 306 performs a network diagnostic on the sub-line.

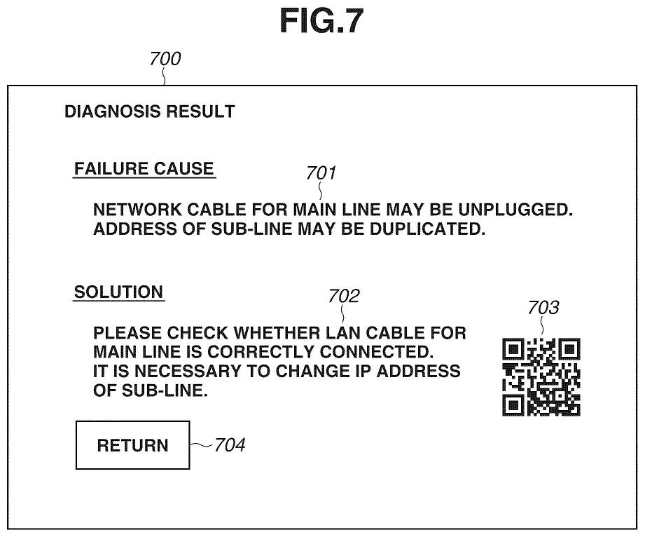

In step S605, a diagnosis result as illustrated in FIG. 7 is displayed. The configuration illustrated in FIG. 7 is similar to the configuration illustrated in FIG. 5.

In step S606, the network diagnostic unit 306 performs a network diagnostic on the main line. For the second setting, the main line is used, so that there is no need to diagnose the sub-line. Thus, a diagnostic on the sub-line is not performed. This enables a diagnostic to be performed with unnecessary diagnostic processing not being performed. After that, a diagnosis result of the network diagnostic in the step S606 is displayed on the operation unit 102 and the sequence is completed.

FIG. 7 is a diagram illustrating an example of a diagnosis result 700 in a case where a diagnostic on the main line and a diagnostic on the sub-line are performed in the state where the MFP 100 is set to the first setting. Display contents 701-704 in FIG. 7 correspond to 501-504 in FIG. 5. In the case of the first setting, the display unit displays diagnosis results of both the main line and the sub-line irrespective of the line used for execution of the job. For example, if the diagnostic is performed on a job that used the main line and the error cause is found in the main line while no error occurs in the sub line, the user can recognize that the user can reconfigure the setting to use the sub line to perform the job.

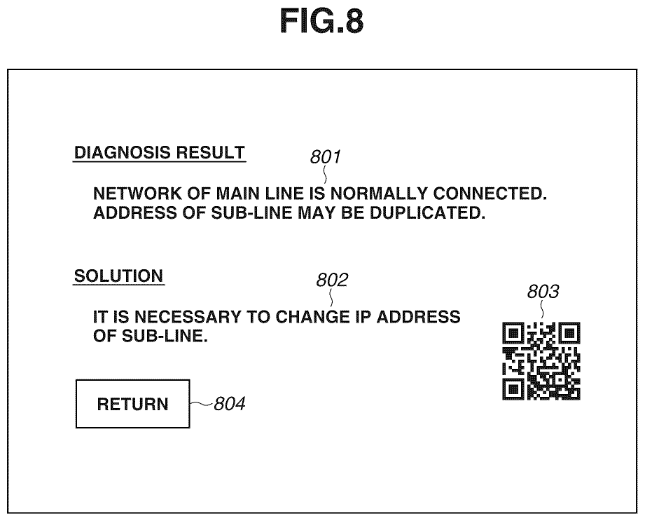

FIG. 8 is a diagram also illustrating a diagnosis result by the display unit. Display contents 801 to 804 in FIG. 8 correspond to 701 to 704 in FIG. 7. As illustrated in a message 801 in FIG. 8, a diagnostic result may indicate that the state is normal. This enables the user to be accurately notified of the network state.

In the present exemplary embodiment, the MFP includes the two communication lines, namely, the main line and the sub-line, but the sub-line is optionally mounted. In the MFP not mounted with the sub-line, no network diagnostics on the sub-line are performed. The user can optionally set whether to use the sub-line in a state where the optional sub-line is mounted.

In a state where the sub-line is usable, the user performs setting for using the sub-line. In the present exemplary embodiment, the network I/F 208 that transmits data to other apparatuses is included, and the sub-line is used for transmitting the data to a predetermined IP address. The predetermined IP address is previously registered by the user. The predetermined IP address and the sub-line are registered in association with each other, so that the sub-line is used in data transmission to the predetermined IP address or data reception from the predetermined IP address.

In a case where data is transmitted to (or data is received from) an IP address that is not registered as the IP address that uses the sub-line, the main line is used.

As described above, the present exemplary embodiment provides the cause of a failure or error to the user through the diagnostic on a wired line in the configuration in which a plurality of wired lines is usable. In the first exemplary embodiment, the line to be diagnosed is selected based on whether the setting is the first setting or the second setting, so that the diagnostic can be performed with the unused line not being diagnosed.

A second exemplary embodiment will now be described. In the present exemplary embodiment, diagnostics for a pattern in which a job and information on a line are associated with each other is described. Description of the same portions as in the first exemplary embodiment is omitted.

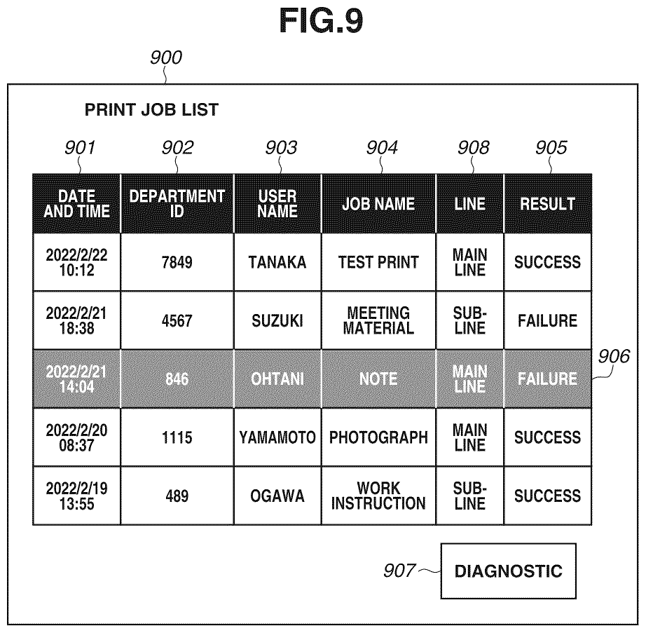

FIG. 9 illustrates, in addition to the data fields illustrated in FIG. 4, information indicating from which network, either the LAN 110 or the LAN 120, the print job has been received, such as a data field “line” 908. Thus, a diagnostic of the corresponding line can be performed. In the print job list 900, the data fields 901 to 905 and the diagnostic button 907 correspond to the data fields 401 to 405 and the diagnostic button 407, respectively.

### <Processing>

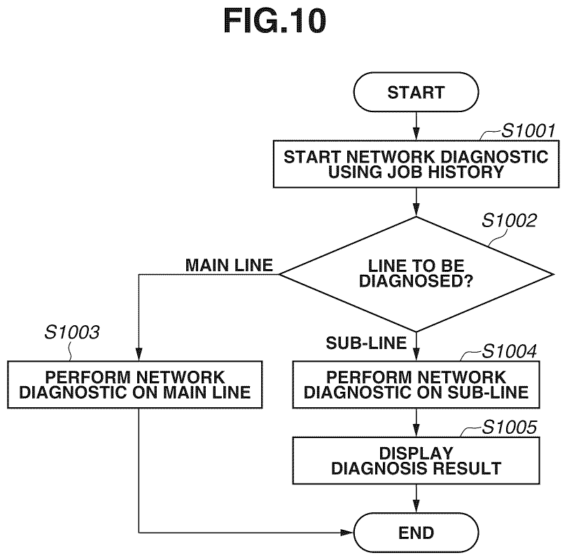

The network diagnostic processing based on the job history according to the present exemplary embodiment will now be described with reference to FIG. 10. When an item 906 in FIG. 9 is selected through the operation unit 102, and the operation unit 102 further receives the selection of the diagnostic button 907, in step S1001, a diagnostic starts.

In step S1002, the information about the line corresponding to the job is acquired from the data field “line” 908 illustrated in FIG. 9. If the line information indicates the main line (MAIN LINE in step S1002), the processing proceeds to step S1003. If the line information indicates the sub-line (SUB-LINE in step S1002), the processing proceed to step S1004.

In step S1003, the network diagnostic unit 306 performs a network diagnostic of the main line.

The processing proceeds to step S1005, and a diagnosis result is displayed.

In step S1004, the network diagnostic unit 306 performs a network diagnostic on the sub-line.

Then the processing proceeds to step S1005.

As described above, according to the present exemplary embodiment, the line to be diagnosed is selected based on the line used for the job of the selected item. This enables the narrowing down of the line to be diagnosed, thus reducing the diagnostic time.

A third exemplary embodiment will be described. In the present exemplary embodiment, instead of displaying diagnosis results for both the main and sub lines, the process through which the user determines the line to be diagnosed will be described.

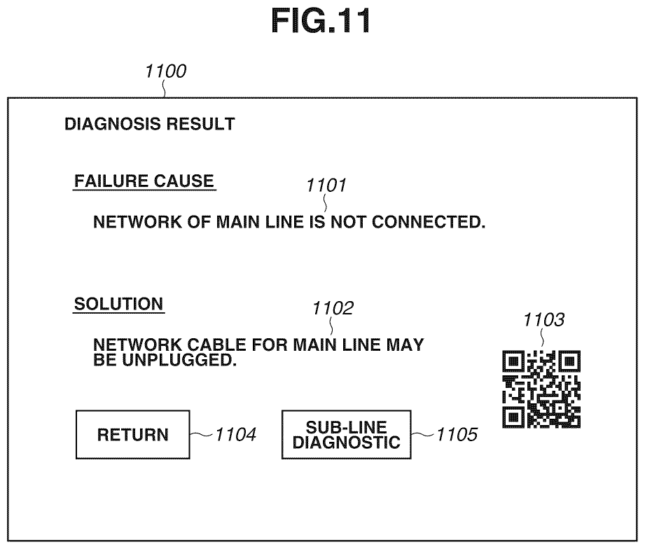

FIG. 11 is a diagram also illustrating a diagnosis result by the display unit. Display contents 1100 to 1104 in FIG. 11 correspond to 700 to 704 in FIG. 7. In FIG. 11, in addition to the information illustrated in FIG. 7, a sub-line diagnostic button 1105 is included. A sub-line diagnostic is performed in response to detecting the button being pressed.

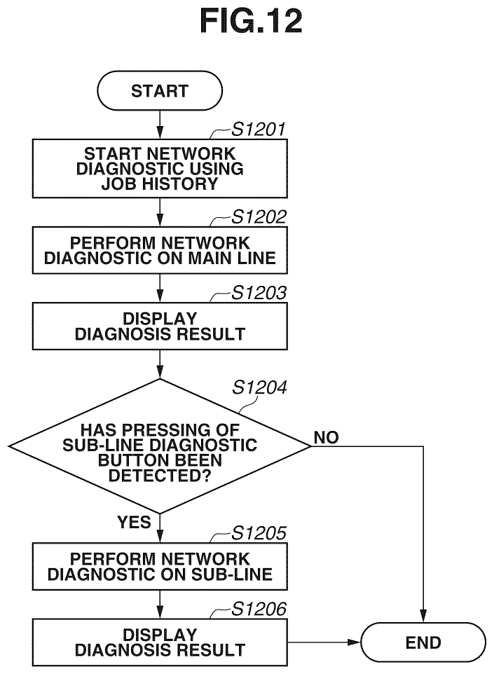

The network diagnostic processing using a job history according to the present exemplary embodiment is described with reference to FIG. 12. In step S1201, when an item is selected from the print job list 900 and the diagnostic button 907 is selected, a diagnostic about a job history record corresponding to the selected item starts. In step S1202, the main line is diagnosed irrespective of the line used for the job of the selected item.

In step S1203, only a diagnosis result of the main line, out of the main line and the sub-line, is displayed.

In step S1204, if the user presses the sub-line diagnostic button 1105 (YES in step S1204), the processing proceeds to step S1205. If the sub-line diagnostic button 1105 is not pressed (NO in step S1204), the diagnostic is ended.

In step S1205, the network diagnostic unit 306 performs a network diagnostic on the sub-line.

In step S1206, only a result of the diagnostic performed on the sub-line line, out of the main line and the sub-line, is displayed.

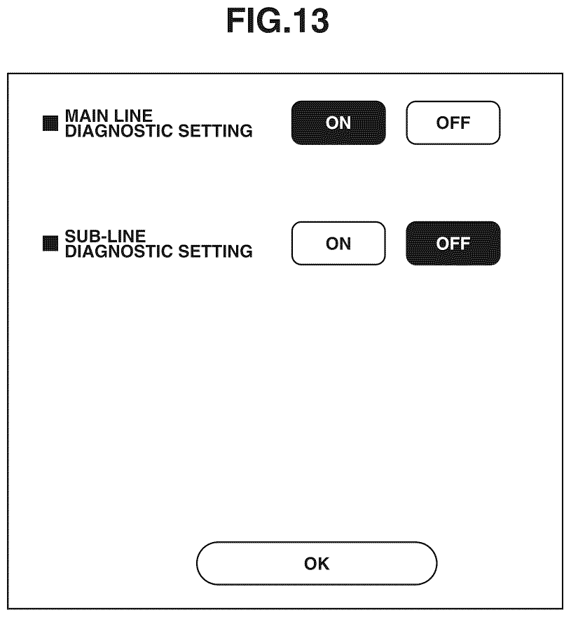

As illustrated in FIG. 13, a setting unit that determines whether to perform a diagnostic for each of the main line and the sub-line may be provided.

This enables the diagnostic to be performed only when a setting value is ON. In the case of FIG. 13, only the diagnostic on the main line is performed in execution of the diagnostic. Additionally, if there is no sub-line configuration, the setting for the sub-line may be omitted.

As described above, according to the present exemplary embodiment, only the diagnostic information expected by the user can be notified.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-063790, which was filed on Apr. 11, 2024 and which is hereby incorporated by reference herein in its entirety.

What is claimed is:

1. An information processing apparatus that is directly connectable to each of a plurality of wired lines, the information processing apparatus comprising:
at least one memory that stores instructions; and
at least one processor, by executing the instructions, causing the information processing apparatus to:
execute a job using any of the plurality of wired lines;
store job information about one or more jobs executed by the information processing apparatus, in a storage of the information processing apparatus;
receive a selection of a record from among records each relating to a corresponding job of the one or more jobs that are managed based on the job information stored in the storage; and
perform a diagnostic on a wired line used in a job corresponding to the selected record.

2. The information processing apparatus according to claim 1, further comprising a printing unit configured to perform printing, wherein the printing unit performs printing based on a job received using any of the plurality of wired lines.

3. The information processing apparatus according to claim 1, further comprising:
a reading unit configured to read a document and to generate image data; and
an interface configured to transmit the image data by using any of the plurality of wired lines,
wherein the interface transmits the image data generated by the reading unit by using any of the plurality of wired lines to execute a job.

4. The information processing apparatus according to claim 1, wherein diagnostics are performed on all of the wired lines connected to the information processing apparatus.

5. The information processing apparatus according to claim 1, further comprising a display configured to display, as a result of the diagnostic, information about the wired line used in the job corresponding to the selected record and a result of the diagnostic regarding the wired line.

6. The information processing apparatus according to claim 1, wherein, for selection of the record, as information about the job corresponding to the item, information about the wired line used in the job is provided.

7. The information processing apparatus according to claim 1,
wherein the at least one processor, by executing the instructions, further cause the information processing apparatus to perform one of a plurality of settings including a first setting and a second setting, the first setting being a setting that enables use of both a first wired line and a second wired line among the plurality of wired lines, the second setting being a setting that enables use of the first wired line but not the second wired line,
wherein, in a case of the first setting, a diagnostic regarding at least any of the first wired line and the second wired line, used in the job corresponding to the selected record, is performed.

8. The information processing apparatus according to claim 7, wherein, in a case of the second setting, only a diagnostic regarding the first wired line is performed with a diagnostic regarding the second wired line not being performed.

9. A method for an information processing apparatus that is directly connectable to each of a plurality of wired lines, the method comprising:
executing a job using any of the plurality of wired lines;
storing job information about one or more jobs executed by the information processing apparatus, in a storage of the information processing apparatus;
receiving a selection of a record from among records each relating to a corresponding job of the one or more jobs that are managed based on the job information stored in the storage; and
performing a diagnostic on a wired line used in a job corresponding to the selected record.

10. A non-transitory computer readable storage medium storing computer-executable instructions for causing a computer execute a method for an information processing apparatus that is directly connectable to each of a plurality of wired lines, the method comprising:
executing a job using any of the plurality of wired lines;
storing job information about one or more jobs executed by the information processing apparatus, in a storage of the information processing apparatus;
receiving a selection of a record from among records each relating to a corresponding job of the one or more jobs that are managed based on the job information stored in the storage; and
performing a diagnostic on a wired line used in a job corresponding to the selected record.
